(19) United States
(12) Patent Application Publication
(10) Pub. No.: US 2012/0274872 A1
(43) Pub. Date: Nov. 1, 2012

(54) CONNECTING DEVICE FOR LED LIGHT BAR, BACKLIGHT MODULE AND LIQUID CRYSTAL DISPLAY DEVICE

(75) Inventor: Gang Yu, Shenzhen (CN)

(73) Assignee: SHENZHEN CHINA STAR OPTOELECTRONICS TECHNOLOGY CO.,, SHENZHEN (CN)

(21) Appl. No.: 13/148,494

(22) PCT Filed: Jun. 17, 2011
(86) PCT No.: PCT/CN11/75885

§ 371 Date: Aug. 9, 2011

(30) Foreign Application Priority Data
Apr. 29, 2011 (CN) 201120134996.7

(51) Int. Cl. G02F 1/1337; G09F 13/04; F21V 21/00

(52) U.S. Cl. 349/61; 362/217.17; 362/97.1

(57) ABSTRACT

The invention discloses a connecting device for an LED light bar, including a clamping slot component, wherein the inside of the front side opening is connected with the LED light bar, the plane of the back side is provided with a through hole, and the side wall thereof is provided with a side hole for accessing a cable and connecting with a conducting region of said LED light bar; a pressing plate, which is arranged into a cavity of said clamping slot component capable of moving along the side wall; a lifting rod, one end of which penetrates said through hole and is fixedly connected with said pressing plate and the other end is arranged outside of the back side of said clamping slot component; and an elastic component, which is sleeved on said lifting rod and is positioned between the inner roof of the clamping slot component and the pressing plate. The invention further discloses a backlight module and a liquid crystal display device applied said connecting device for the LED light bar. The connecting device for the LED light bar and the backlight module provided by the invention are characterized in simple structure and low cost.

### FIELD OF THE INVENTION

The invention relates to the field of backlight, in particular to a connecting device for an LED light bar, a backlight module and a liquid crystal display device.

### BACKGROUND OF THE INVENTION

In present backlight fields, many LED (Light Emitting Diode) light bar are electrically connected with the outer components via a connector, and the connector is welded on the LED light bar with the method of pasting chips. Take FIG. 1 and FIG. 2 as references, which are the schematic diagrams for the connecting structure between a connector and an LED light bar. The connector 10 is a square cavity, which is welded on the LED light bar 20 with the method of pasting chips. However, such method has the following disadvantages. On one side, the unit price of the connector 10 is higher; on the other side, it needs a certain cost for pasting chips. And the two factors lead to the excessive cost for connecting the LED light bar and the outer component.

### SUMMARY OF THE INVENTION

The main purpose of the invention is to provide a connecting device for LED light bar, a backlight module and a liquid crystal display device. It aims to realize the convenience for connecting and dismounting the power-supply wires of the LED light bar. Besides, it is featured in simple structure and low cost.

The invention discloses a connecting device for the LED light bar, including:

a clamping slot component, wherein the inside of the front side opening is connected with the LED light bar, the plane of the back side is provided with a through hole, and the side wall thereof is provided with a side hole for accessing a cable and connecting with a conducting region of said LED light bar;

a pressing plate, which is arranged into a cavity of said clamping slot component capable of moving along the side wall;

a lifting rod, one end of which penetrates said through hole and is fixedly connected with said pressing plate and the other end is arranged outside of the back side of said clamping slot component; and an elastic component, which is sleeved on said lifting rod and is positioned between the inner roof of the clamping slot component and the pressing plate.

Preferably, said pressing plate is provided with a projection, said LED light bar is provided with an opening hole matched with said projection for limiting the said LED light bar moving left and right.

Preferably, said clamping slot component is a C-shaped clamping slot.

Preferably, the upper end of said pressing plate far away from said side hole is provided with a boss for locating the cable.

Preferably, said boss and said pressing plate are integrated into a whole.

Preferably, the maximum interval between said pressing plate and the inner roof of said clamping slot component is less than the length of said elastic component when it is in a free state.

Preferably, said elastic component is a spring or a spring lamination.

Preferably, the shape of the cross section of said lifting rod is a circle, a rectangle or a triangle.

Preferably, said lifting rod and said pressing plate are connected by the ways of threading, welding or riveting.

The invention further discloses a backlight module, comprising a connecting device for the LED light bar. Said connecting device for the LED light bar includes:

a clamping slot component, wherein the inside of the front side opening is connected with the LED light bar, the plane of the back side is provided with a through hole, and the side wall thereof is provided with a side hole for accessing a cable and connecting with a conducting region of said LED light bar;

a pressing plate, which is arranged into a cavity of said clamping slot component capable of moving along the side wall;

a lifting rod, one end of which penetrates said through hole and is fixedly connected with said pressing plate and the other end is arranged outside of the back side of said clamping slot component; and

an elastic component, which is sleeved on said lifting rod and is positioned between the inner roof of the clamping slot component and the pressing plate.

Preferably, said pressing plate is provided with a projection, said LED light bar is provided with an opening hole matched with said projection for limiting the movement of said LED light bar.

Preferably, said clamping slot component is a C-shaped clamping slot.

Preferably, one side of said pressing plate close to said LED light bar is provided with a boss for locating the cable.

Preferably, said boss and said pressing plate are integrated into a whole.

Preferably, the maximum interval between said pressing plate and the inner roof of said clamping slot component is less than the length of said elastic component when it is in a free state.

Preferably, said elastic component is a spring or a spring lamination.

The invention further discloses a liquid crystal display device, comprising a backlight module and said backlight module includes a connecting device for the LED light bar, wherein said connecting device for the LED light bar includes:

a clamping slot component, wherein the inside of the front side opening is connected with the LED light bar, the plane of the back side is provided with a through hole, and the side wall thereof is provided with a side hole for accessing a cable and connecting with a conducting region of said LED light bar;

a pressing plate, which is arranged into a cavity of said clamping slot component capable of moving along the side wall;

a lifting rod, one end of which penetrates said through hole and is fixedly connected with said pressing plate and the other end is arranged outside of the back side of said clamping slot component; and

an elastic component, which is sleeved on said lifting rod and is positioned between the inner roof of the clamping slot component and the pressing plate.

Preferably, said pressing plate is provided with a projection, said LED light bar is provided with an opening hole matched with said projection for limiting the movement of said LED light bar.

Preferably, the cross section of said C-shaped clamping slot component is a rectangle having a gap on one side.

Preferably, said liquid crystal display device is a liquid crystal display television.

In the connecting device of the LED light bar of the invention, the front side of the clamping slot component is connected with the end part of the LED light bar. The cables connected with the external power supply can be led in from the side hole of the clamping slot component. Under the extrusion effect of the elastic component, the pressing plate presses the cables into the conducting region of the LED light bar to finish the connecting between the LED light bar and the external component. The invention realizes the convenience for connecting and dismounting the power-supply wires of the LED light bar. Besides, it is featured in simple structure and low cost.

### DESCRIPTION OF ATTACHED DRAWINGS

FIG. 1 is the schematic diagram for the structure of the present connector;

FIG. 2 is the schematic diagram for the connecting structure between the connector and the LED light bar;

FIG. 3 is the schematic diagram of the three-dimensional structure in the first exemplary embodiment of the connecting device for LED light bar disclosed by the invention;

FIG. 4 is the schematic diagram of the vertical section of the connecting device for the LED light bar in FIG. 3;

FIG. 5 is the schematic diagram of a using state structure of the connecting device for the LED light bar in FIG. 3;

FIG. 6 is the schematic diagram of the using state structure of the second exemplary embodiment of the connecting device for the LED light bar disclosed by the invention;

FIG. 7 is the schematic diagram of the using state structure of the third exemplary embodiment of the connecting device for the LED light bar disclosed by the invention.

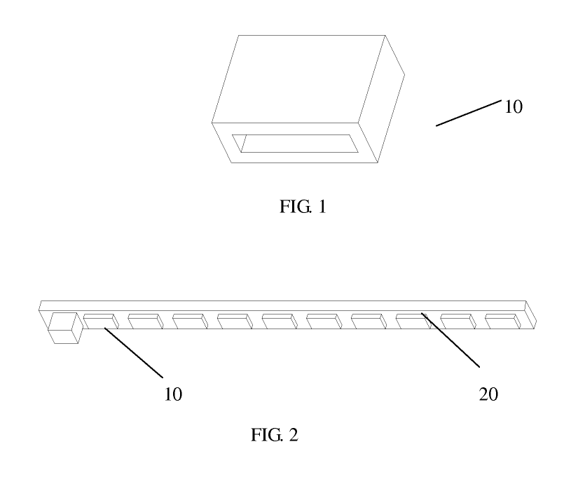

The purpose implementation, the function features and advantages of the invention will be further illustrated by integrating the exemplary embodiments and taking the attached drawings as references.

### DETAILED DESCRIPTION OF THE EMBODIMENTS

It should be understood that the described exemplary embodiment is only used for illustrating this invention rather than limiting.

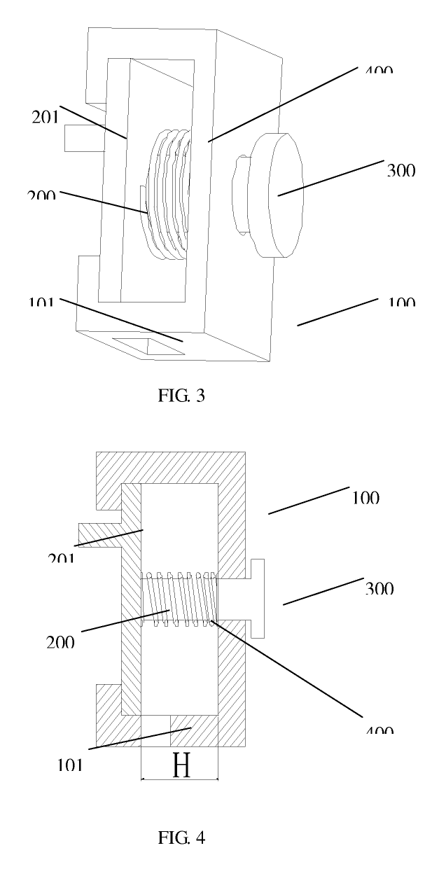

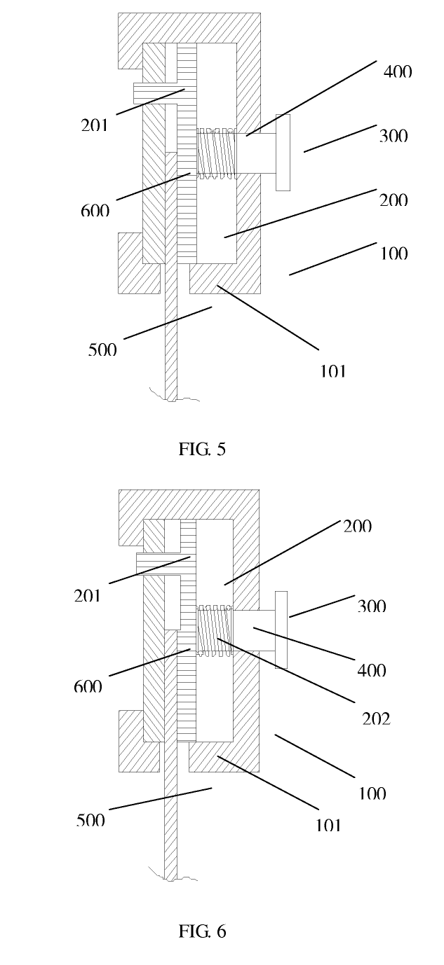

Take FIG. 3, FIG. 4 and FIG. 5 as a reference, which disclose the first exemplary embodiment of the connecting device for the LED light bar of the invention. In this exemplary embodiment, the connecting device for the LED light bar includes a clamping slot component 100, a pressing plate 200, a lifting rod 300 and an elastic component 400, wherein the inside of the front side opening of the clamping slot component 100 is connected with the LED light bar 600 and is fixed with the external LED light bar 600. The opening at the front side is used for light transmitting of the LED light bar 600, the plane at the back side is provided with a through hole, the side wall is provided with a side hole 101. The hole 101 is used for leading in the cable 500 and connecting with the conducting region at one end of the LED light bar 600. The conducting region is the copper leakage region on the LED light bar 600 for connecting with the power supply. The cable 500 is used for connecting with the external power supply. The clamping slot component of this exemplary embodiment is a C-shaped clamping slot. It can be understood that the C-shaped clamping slot is a component with a rectangle-shaped cross section and with a gap on one side.

Said pressing plate 200 is arranged into the cavity of said clamping slot component 100, capable of moving left and right along the side wall, i.e. capable of moving forward and backward in the clamping slot component 100.

One end of said lifting rod 300 penetrates said through hole to be fixedly connected with said pressing plate 200, and the other end thereof is arranged outside of the back side of said clamping slot component 100. Said pressing plate 200 is able to move forward and backward by drawing one end of said lifting rod 300 that is arranged outside of said clamping slot component 100.

Said elastic component 400 is sleeved on said lifting rod 300 and is positioned between the inner roof of the clamping slot component 100 and the pressing plate 200. The two ends of the elastic component 400 are supported on said pressing plate 200 and the inner roof of the clamping slot component 100, respectively.

One side of said pressing plate 200 close to the LED light bar 600 is provided with a projection 201 for locating the LED light bar 600. An opening hole is arranged on the corresponding LED light bar 600 which is matched with said projection 201 for limiting the LED light bar 600 moving left and right. The projection 201 is inserted into the hole of the LED light bar 600 in order to make the LED light bar 600 positioned in the left direction and the right direction.

When the LED light bar 600 is connected with the external power supply via the connecting device of the LED light bar, firstly, drawing the lifting rod 300 externally, then making the conducting region on one end of the LED light bar 600 slide from one side end of the clamping slot component 100 into the clamping slot component 100 and be clamped in it, and after that, inserting the cable 500 that is connected with the external power supply from the side hole 101 into a position corresponding to the conducting area of the LED light bar 600, lastly loosening the lifting rod 300. Under the effect of the elastic component 400, the pressing plate 200 presses the cable 500 into the conducting region of the LED light bar 600 to realize the connection between the LED light bar and the power supply. The invention realizes the convenience for connecting and dismounting the power-supply wires of the LED light bar 600. Besides, it is featured in simple structure and low cost.

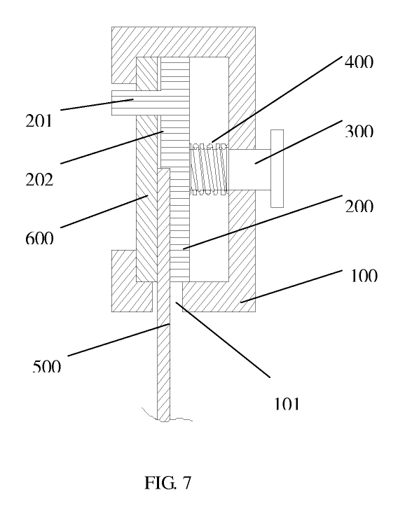

Take FIG. 6 as a reference, which is the second exemplary embodiment of the connecting device for the LED light bar disclosed by the invention. This exemplary embodiment includes all the mentioned technical schemes and is further provided with at least one boss 202 on one side of said pressing plate 200 capable of extruding with said cable 500. The boss 202 is arranged below the pressing plate 200 and is close to one side of the LED light bar 600. Since the boss 202 is extruded with the cable 500, thus the stressing surface area is reduced and the pressure is enhanced so that the cable 500 can be more firmly connected with the conducting region of the LED light bar 600. The boss 202 can be arranged according to the pin of the cable 500, that is, a plurality of bosses 202 are arranged and respectively corresponded to and fitted with the position of each pin of the cable 500. Each boss 202 is used for extruding a pin of the cable 500 to ensure better conducting and contacting.

The maximum interval H between the back side of said pressing plate 200 and said clamping slot component 100 is less than the length of the elastic component 400 under the state of no elasticity. The elastic component 400 always lies in a pressing state within the clamping slot component 100. That is to say, the elastic component 400 always lies in a compressed state so as to guarantee the elastic component 400 to have sufficient compressing amount and guarantee the connection reliability.

Said elastic component 400 can use a spring or a spring lamination and other elastic components.

The shape of the cross section of said lifting rod 300 is a circle, a rectangle or a triangle and other shapes.

Said lifting rod 300 and said pressing plate 200 are connected together by the ways of threading, welding or riveting and other ways.

Said boss 202 and said pressing plate 200 are molded separately. Said boss 202 is inlaid into said pressing plate 200. Or, said boss 202 and said pressing plate 200 are molded integrally, so that the manufacturing technique is reduced and the working efficiency is improved.

Take FIG. 7 as a reference, which is the third exemplary embodiment of the connecting device for the LED light bar disclosed by the invention. It has the following differences on the basis of said exemplary embodiment in FIG. 6 that the arranging positions of said boss 202 are different. The boss 202 of this exemplary embodiment is arranged on the upper part of said pressing plate 200 close to one side of the LED light bar 600. The boss 202 is provided with at least one for limiting the position of said cable 500. Such boss 202 is not directly extruded with the cable 500, so that it can not only have the same effects of above exemplary embodiment with more reliable connection, it can also have the effect of limiting the position of the cable 500. The cable 500 is inserted from the side hole 101 and supported on the boss 202 to determine its connecting position so as to make it faster to be installed.

The invention further discloses a backlight module. Such backlight module adopts all the technical schemes of the exemplary embodiments for said connecting device of the LED light bar, which have the same technical effects. Therefore, the technical scheme and the technical effect of the connecting device for the LED connecting device will not be illustrated in details.

The invention further discloses a liquid crystal display device, including a backlight module. The backlight module includes a connecting device for the LED light bar, and the connecting device for the LED light bar includes:

a clamping slot component 100, which is a C-shaped clamping slot component, the cross section of said C-shaped clamping slot component is a rectangle with one side having a gap, wherein the inside of the front side opening is connected with the LED light bar 600, the plane of the back side is provided with a through hole, and the side wall thereof is provided with a side hole for accessing the cable 500 that is connected with the external power supply and connecting with the conducting region of said LED light bar 600;

a pressing plate, which is arranged into the cavity 100 of said clamping slot component 100 capable of moving along the side wall, the pressing plate 200 is provided with a projection 201, the LED light bar 600 is provided with an opening hole matched with such projection 201 for limiting the movement of the LED light bar 600;

a lifting rod 300, one end of which penetrates said through hole and is fixedly connected with said pressing plate 200 and the other end is arranged outside of the back side of said clamping slot component 100;

and an elastic component 400, which is sleeved on said lifting rod 300 and is positioned between the inner roof of the clamping slot component 100 and the pressing plate 200.

The liquid crystal display device of this exemplary embodiment can be a liquid crystal display television, which is convenient to connect and dismount the power supply wires of the LED light bar 600 and is further featured in simple structure and low cost. The connecting device of the LED light bar in this exemplary embodiment further includes other technical schemes of said exemplary embodiments of the connecting device for the LED light bar, however, the effects are same. Here will not illustrate it in details.

What is illustrated above is just a preferable exemplary embodiment, which will not limit the patent scope of the invention. Any equivalent replacements made by the specifications and drawings of the invention, which are directly or indirectly applied to other technical fields, should be all included into the protection scope of the invention.

What is claimed is:

1. A connecting device for the LED light bar, comprising:
a clamping slot component, wherein the inside of the front side opening is connected with the LED light bar, the plane of the back side is provided with a through hole, and the side wall thereof is provided with a side hole for accessing a cable and connecting with a conducting region of said LED light bar;
a pressing plate, which is arranged into a cavity of said clamping slot component capable of moving along the side wall;
a lifting rod, one end of which penetrates said through hole and is fixedly connected with said pressing plate and the other end is arranged outside of the back side of said clamping slot component; and
an elastic component, which is sleeved on said lifting rod and is positioned between the inner roof of the clamping slot component and the pressing plate.

2. The connecting device for the LED light bar of claim 1, wherein said pressing plate is provided with a projection, and said LED light bar is provided with an opening hole matched with said projection for limiting the movement of said LED light bar.

3. The connecting device for the LED light bar of claim 2, wherein said clamping slot component is a C-shaped clamping slot.

4. The connecting device for the LED light bar of claim 3, wherein one side of said pressing plate close to said LED light bar is provided with a boss for locating the cable.

5. The connecting device for the LED light bar of claim 4, wherein said boss and said pressing plate are integrated into a whole.

6. The connecting device for the LED light bar of claim 5, wherein the maximum interval between said pressing plate and the inner roof of said clamping slot component is less than the length of said elastic component when it is in a free state.

7. The connecting device for the LED light bar of claim 6, wherein said elastic component is a spring or a spring lamination.

8. The connecting device for the LED light bar of claim 1, wherein the shape of the cross section of said lifting rod is a circle, a rectangle or a triangle.

9. The connecting device for the LED light bar of claim 8, wherein said lifting rod and said pressing plate are connected by the ways of threading, welding or riveting.

10. A backlight module, comprising a connecting device of the LED light bar, wherein said connecting device of the LED light bar comprises:
a clamping slot component, wherein the inside of the front side opening is connected with the LED light bar, the plane of the back side is provided with a through hole, and the side wall thereof is provided with a side hole for accessing a cable and connecting with a conducting region of said LED light bar;
a pressing plate, which is arranged into a cavity of said clamping slot component capable of moving along the side wall;
a lifting rod, one end of which penetrates said through hole and is fixedly connected with said pressing plate and the other end is arranged outside of the back side of said clamping slot component; and
an elastic component, which is sleeved on said lifting rod and is positioned between the inner roof of the clamping slot component and the pressing plate.

11. The backlight module of claim 10, wherein said pressing plate is provided with a projection, and said LED light bar is provided with an opening hole matched with said projection for limiting the movement of said LED light bar.

12. The backlight module of claim 11, wherein said clamping slot component is a C-shaped clamping slot.

13. The backlight module of claim 12, wherein one side of said pressing plate close to said LED light bar is provided with a boss for locating the cable.

14. The backlight module of claim 13, wherein said boss and said pressing plate are integrated into a whole.

15. The backlight module of claim 14, wherein the maximum interval between said pressing plate and the inner roof of said clamping slot component is less than the length of said elastic component when it is in a free state.

16. The backlight module of claim 15, wherein said elastic component is a spring or a spring lamination.

17. A liquid crystal display device, comprising a backlight module and said backlight module comprises a connecting device for the LED light bar, wherein said connecting device for the LED light bar comprises:
a clamping slot component, wherein the inside of the front side opening is connected with the LED light bar, the plane of the back side is provided with a through hole, and the side wall thereof is provided with a side hole for accessing a cable and connecting with a conducting region of said LED light bar;
a pressing plate, which is arranged into a cavity of said clamping slot component capable of moving along the side wall;
a lifting rod, one end of which penetrates said through hole and is fixedly connected with said pressing plate and the other end is arranged outside of the back side of said clamping slot component; and
an elastic component, which is sleeved on said lifting rod and is positioned between the inner roof of the clamping slot component and the pressing plate.

18. The liquid crystal display device of claim 17, wherein said pressing plate is provided with a projection, and said LED light bar is provided with an opening hole matched with said projection for limiting the movement of said LED light bar.

19. The liquid crystal display device of claim 18, wherein the cross section of said C-shaped clamping slot component is a rectangle having a gap on one side.

20. The liquid crystal display device of claim 19, wherein said liquid crystal display device is a liquid crystal display television.
